(19) United States
(12) Patent Application Publication
(10) Pub. No.: US 2024/0220969 A1
(43) Pub. Date: Jul. 4, 2024

(54) SYSTEM AND METHOD FOR RECORDING OWNERSHIP IN DIGITAL REAL ESTATE IN A BLOCKCHAIN-BASED DIGITAL PLATFORM

(71) Applicant: Randall William MARUSYK, Ottawa (CA)

(72) Inventor: Randall William MARUSYK, Ottawa (CA)

(21) Appl. No.: 18/603,697

(22) Filed: Mar. 13, 2024

Related U.S. Application Data
(63) Continuation-in-part of application No. 17/838,088, filed on Jun. 10, 2022, now abandoned.
(60) Provisional application No. 63/209,742, filed on Jun. 11, 2021.

(51) Int. Cl. G06Q 20/36; G06Q 20/08; G06Q 50/16

(52) U.S. Cl. CPC G06Q 20/3674; G06Q 20/0855; G06Q 50/16

(57) ABSTRACT

The invention relates to a method and system for recording ownership and transfer of digital real estate. A method automates digital assets generation associated with digital real estate located within a blockchain-based digital platform. The method also includes determining a unique owner identification code associated with the second party, generating a digital asset associated with the digital real estate. The method transmits the unique digital real estate ID code and the unique owner ID code to record a transfer of the digital asset to the second party. It also determines a new unique owner ID code of the third party, links the digital asset with the new unique owner ID code and transmits the unique digital real estate ID code and the new unique owner ID code to the distributed blockchain-based ledger for recordation on a new transaction block.

### CROSS-REFERENCE TO RELATED APPLICATIONS

This application claims benefit of priority to U.S. Provisional Patent Application U.S. Patent Application Ser. No. 63/209,742 entitled “System and Method for Recording Ownership in Digital Real Estate in a Generic Digital Platform” filed Jun. 11, 2021 the contents of which are hereby incorporated by reference in their entirety.

### FIELD

The present invention relates generally to the field of blockchain technologies and transactions, and more particularly to a blockchain system and method for authenticating property rights related to digital real estate and a system and method for blockchain transactions for transferring said property rights in digital real property or digital real estate.

### BACKGROUND

In many jurisdictions around the world, to be valid and enforceable, real property rights, including changes in ownership, must be recorded in a land registry. This is because the land registry is the public ledger that records all legally recognized transactions related to the property rights of real property.

A land registry identifies a specific parcel of land through a specific identification code assigned to the real property.

Information included in the land registry describes the individual characteristics of the real property. Information found in the public ledger includes but is not limited to the current status and ownership history, the structure of ownership, any legal obligations or charges attached to the real property which can include a lien against the real property, any easements, and any other legal changes related to the rights and obligations of the real property.

However, the prior art does not address recording digital real property information in a publicly accessible registry where the digital real property exists in a metaverse. Accordingly, there is a need for a method and a system used to record real property information in a metaverse that at least partially addresses one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

An object of the present disclosure is to provide a method and system for trusted, secure, transparent, and traceable publicly accessible records regarding the chain of title or ownership history of a virtual property on a digital platform. More specifically, the present disclosure relies on the trust established in and by blockchain-based technology to enable an organization to control the creation, distribution, characteristics, and use of digital real estate that is present in their blockchain-based digital platform. Furthermore, technology described in this disclosure enables the organization to limit the overall supply of digital real estate to create controlled scarcity if desired.

In accordance with a first embodiment of the present disclosure, a method for automating the generation of cryptographic digital assets associated with digital real estate located within a blockchain-based digital platform is presented. Digital real estate may contain other permanent digital assets (digital fixtures) and/or non-permanent digital asset (digital chattels).

Another aspect of this embodiment includes receiving a transaction confirmation indicative of a validated transfer of digital real estate from a first party to a second party using one or more blockchain-based transactions, the digital realestate being located within the blockchain-based digital platform and being associated with the digital assets.

Another aspect of this embodiment also includes determining a unique owner identification code associated with the second party from an encrypted relational database.

Another aspect of this embodiment also includes generating a cryptographic digital asset associated with the digital real estate, the cryptographic digital asset or digital real estate ID code using one or more blockchain-based transactions where the the cryptographic digital asset is transferable separate from the digital real estate if transferable.

Another aspect of this embodiment also includes linking the cryptographic digital assets with the unique owner ID code using one or more blockchain-based transactions.

Another aspect of this embodiment also includes transmitting to a distributed blockchain ledger, the digital real estate ID code and the owner identification code to record a transfer of the cryptographic digital asset to the second party on a transaction block using one or more blockchain-based transactions.

Another aspect of this embodiment also includes receiving a digital transfer proposal with a request to transfer the cryptographic digital asset to a third party and determining a new unique owner ID code associated with the third party using one or more blockchain-based transactions.

Another aspect of this embodiment further includes linking the cryptographic digital asset with the new unique owner ID code and transmitting the unique digital real estate ID code and the new unique owner ID code to the distributed block-chain ledger for recordation on a new transaction block using one or more blockchain-based transactions.

Embodiments have been described above in conjunction with aspects of the present disclosure upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those skilled in the art.

### BRIEF DESCRIPTION OF THE FIGURES

Further features and advantages of the present disclosure will become apparent from the following detailed description, taken in combination with the appended drawings, in which:

FIG. 1 depicts a method according to embodiments of the present disclosure.

FIG. 2 illustrates a system provided in accordance with embodiments of the present disclosure.

FIG. 3 illustrates a system provided in accordance with embodiments of the present disclosure.

FIG. 4 depicts another method according to embodiments of the present disclosure.

FIG. 5 illustrates a computing device that may be configured to execute any of the embodiment as described herein.

It will be noted that throughout the appending drawings, like features are identified by like reference numerals.

### DETAILED DESCRIPTION

Aspects of this disclosure are directed to computer-generated digital real estate that can be linked to a public registry. The public registry may store information on a distributed blockchain-based ledger that can be protected by transferable or non-transferable cryptographic tokens. These tokens can include non-fungible tokens (NFTs).

Individuals located around the world can access a common digital platform using the Internet. This common digital platform can provide a common sensory experience and interaction in the form of virtual environments where individuals can interact with this virtual environment and also other individuals also accessing the virtual environment. The operation of the virtual environment can be based on the same principles as the real world to provide an intuitive experience for individuals.

As a non-limiting example, digital platforms such as the online gaming world of World of Warcraft® includes a virtual world with unique virtual locations. Players can create avatars that represent themselves and these avatars can interact in the virtual world in a similar way to the way individuals interact in the real world.

Another non-limiting example of virtual real estate is a virtual city called Genesis City created by Decantraland. Genesis City includes virtual real estate that can be bought and sold using real world currency.

An NFT is a data unit stored on a blockchain-based digital platform that can be used to certify that a digital asset is unique and therefore not interchangeable. This is different from a fungible token, like the cryptocurrency bitcoin, where one bitcoin or token is indistinguishable from another bitcoin.

NFTs can be used to commodify digital assets by proving the authenticity and ownership history of the digital assets.

Examples of NFTs being used to authenticate digital assets can be found in prior art. For example, Nike's U.S. Ser. No. 10/505,726B1 patent includes the creation of NFTs for authentication of digital assets or cryptographic digital assets associated with footwear.

NFTs and cryptocurrencies are themselves digital assets that are encrypted.

Decentralized Autonomous Organizations (DAO) are organizations that can be created using blockchain-based technology and smart contracts. Smart contracts can be computer programs stored on a blockchain that are executed when one or more predetermined conditions are met. In some embodiments, governing rules or contracts regarding the operation of a corporation, including the corporation's articles of incorporation, can be converted into smart contracts. Since a blockchain-based system is decentralized and autonomous, by using smart contracts, a corporation can also be decentralized and autonomous and can also become a DAO.

The present disclosure contemplates that in some embodiments, digital real estate may be representative of physical real estate.

In some embodiments, the characteristics of digital real estate may be altered by a user's avatar as it interacts with the digital real estate in a virtual environment.

The ownership of the digital real estate may be securely established by a virtual deed or NFT in the form of an encryption-protected block that contains a hash pointer as a link to related block in a decentralized blockchain, a transaction timestamp, and transaction data.

Owners of digital real estate may securely trade, sell, buy, or alter specific property rights related to digital real estate using a smart contract. Also, the NFT linked to digital real estate may be stored in a cryptocurrency wallet or other digital blockchain-based locker.

The interaction of the digital real estate with avatars or other digital assets can result in a change to one or more of the digital real estate's characteristics. As a non-limiting example, these interactions can include the permanent inclusion of an object in the digital real estate such as a digital fixture or a non-permanent inclusion of an object in the digital real estate such as a digital chattel.

In some embodiments, digital real estate's digital fixtures and digital chattels may be included in the blockchain-based public registry.

However, in some embodiments, only users with access to the digital wallet linked with the NFT or digital deed may have permission to alter or transfer the property rights in the digital real estate. These users are also the only users that may have the ability to alter the characteristics of the digital real estate. Non-limiting examples of altering characteristics can include the permanent linking to other digital assets such as digital fixtures or the linking to non-permanent digital chattels (or digital assets).

Aspects of this disclosure can be directed to the registration of digital real estate located within a blockchain-based digital platform. This digital real estate can be protected by cryptographic tokens.

In some embodiments, instead of being linked with real-world physical land, the digital real estate can be linked to a 2 dimensional or 3 dimensional design file, rendering, or drawing package.

As used herein by some embodiments, digital real estate may refer to a computer generated virtual object that can have a NFT code (“token”) registered on a block-chain-based validated platform or otherwise registered in an immutable database.

Each unique token can be directly linked to a single digital real estate object. These objects may be embodied as a virtual reproduction or digital-art version of a specific property. In an embodiment, the token may include a 64-bit alphanumeric code that can be sectioned into individual code segments. One or more of the code segments of the alphanumeric code may express data indicative of attributes of the digital real estate. For instance, a series of code segments may provide digital real estate attributes, such as square footage, number of bathrooms, number of bedrooms, a garage, a pool, lot size and the like. When the digital real estate is added to the digital platform, this blockchain-based transaction can result in the generation of a smart contract used to authenticate ownership and track future transactions related to the sale of the digital real estate.

As a non-limiting example, each authenticated digital real estate can be assigned a unique product identifier (UPID). Upon purchase by a consumer, using a blockchain-based transaction, the UPID can be used to unlock a cryptographic digital asset composed of the digital real estate and a unique NFT operating on a blockchain based distributed computer platform.

In general, before a consumer can unlock or acquire the digital real estate, they may first be required to procure a blockchain-based locker address using a blockchain-based transaction. A blockchain-based locker address is also known to those skilled in the art as an Ethereum hardware wallet. This blockchain-based locker may be used to store, using a blockchain-based transaction, the private key belonging to the digital real estate's NFT and, optionally, may be linked to a personal user account that can be registered with the original owner of the digital real estate.

As a non-limiting example, a digital real estate's UPID can be provided to the owner via a printed or digital receipt, a pop-up message or an email sent to a personal user account, a push notification or text message sent to a smartphone, or some other record. The consumer can use the UPID to link the digital real estate to their digital blockchain-based locker.

Some embodiments may require the consumer to look for a real estate listing for digital real estate in a brick-and-mortar store using a photograph or using an augmented reality function on a handheld personal computing device. In this non-limiting example, the UPID may be provided via the retail transaction. However, the consumer may separately find a hidden UPID in augmented reality within the store or local area before the digital real estate can be transferred to their locker using a blockchain-based transaction. In this non-limiting example, the cryptographic key and the virtual object must both be separately acquired before the transfer can occur. Also in this non-limiting example, obtaining the cryptographic key may enable the augmented reality engine associated with the consumer's device to initiate a game where the digital real estate associated with that key is locally hidden and available for the consumer to locate.

After acquiring the digital real estate using a blockchain-based transaction, the owner may buy, sell, collect or trade digital real estate using, as a non-limiting example, physical, fiat, and/or digital currency. In some embodiments, an entity may maintain a digital online marketplace that can include an inventory of digital real estate for sale and/or a marketplace that may broker transactions between individuals.

As digital real estate is transferred between consumers over time, each blockchain-based sale or trade transaction can be tracked within a blockchain-based ledger of transactions.

In some embodiments, digital real estate may be backed by NFTs, where the digital real estate may represent a monetary value. Certain attributes within the code assigned to the token may dictate worth. This worth may either be allowed to float according to market forces or may be tied to a fiat currency.

This disclosure combines aspects of some or all of: using NFTs to authenticate and prove ownership of digital real estate via a secure distributed blockchain-based ledger, provide access via publicly accessible registry systems, include a decentralized autonomous organization based on blockchain-based technology and smart contracts.

An organization operating the public registry may or may not be separate from the organization operating the virtual environment.

In some embodiments, digital real estate may be linked to a physical location. In some of these embodiments, an organization may facilitate, via the digital real estate, the real-world transaction of physical property including but not limited real property. For example, the virtual real estate may act as a representation of real-world real estate or as a digital location where part of the transfer of assets can be completed.

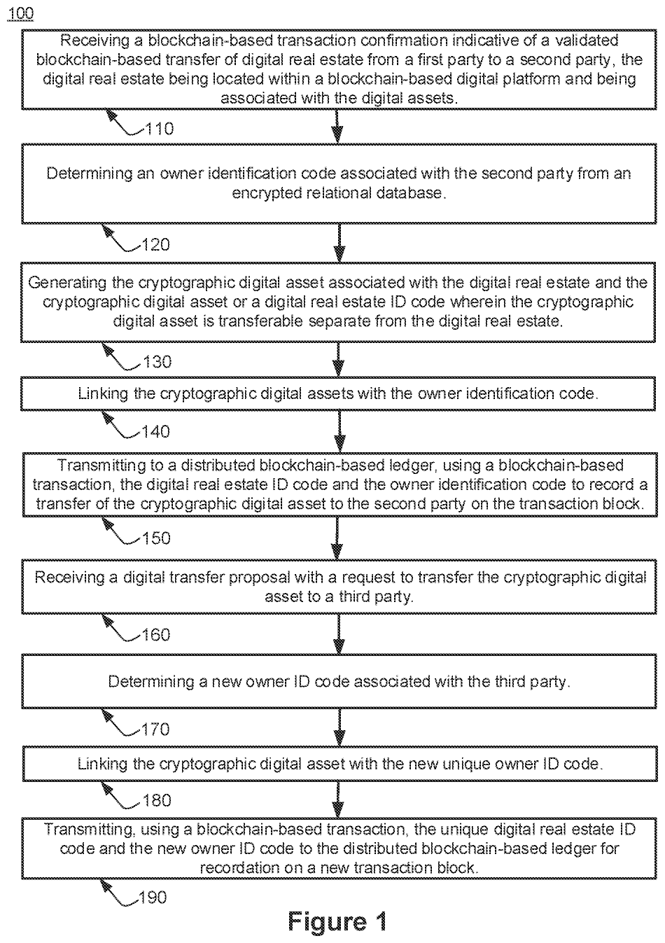

FIG. 1 illustrates method 100 using a flowchart. Method 100 can be used to automate the generation of cryptographic digital assets associated with digital real estate located within a blockchain-based digital platform. Digital real estate may contain other permanent digital assets (digital fixtures) and/or non-permanent digital assets (digital chattels).

Block 110 of FIG. 1 illustrates receiving a blockchain-based transaction confirmation indicative of a validated blockchain-based transfer of digital real estate from a first party to a second party, the digital real estate being located within a blockchain-based digital platform and being associated with the digital assets.

Block 120 of FIG. 1 illustrates determining an owner identification code associated with the second party from an encrypted relational database.

Block 130 of FIG. 1 illustrates generating the cryptographic digital asset associated with the digital real estate and the cryptographic digital asset or a digital real estate ID code wherein the cryptographic digital asset is transferable separate from the digital real estate.

Block 140 of FIG. 1 illustrates linking the cryptographic digital assets with the owner identification code.

Block 150 of FIG. 1 illustrates transmitting to a distributed blockchain-based ledger, using a blockchain-based transaction, the digital real estate ID code and the owner identification code to record a transfer of the cryptographic digital asset to the second party on a transaction block.

Block 160 of FIG. 1 illustrates receiving a digital transfer proposal with a request to transfer the cryptographic digital asset to a third party.

Block 170 of FIG. 1 illustrates determining a new owner ID code associated with the third party.

Block 180 of FIG. 1 illustrates linking the cryptographic digital asset with the new owner ID code.

Block 190 of FIG. 1 illustrates transmitting, using a blockchain-based transaction, the unique digital real estate ID code and the new owner ID code to the distributed blockchain-based ledger for recordation on a new transaction block.

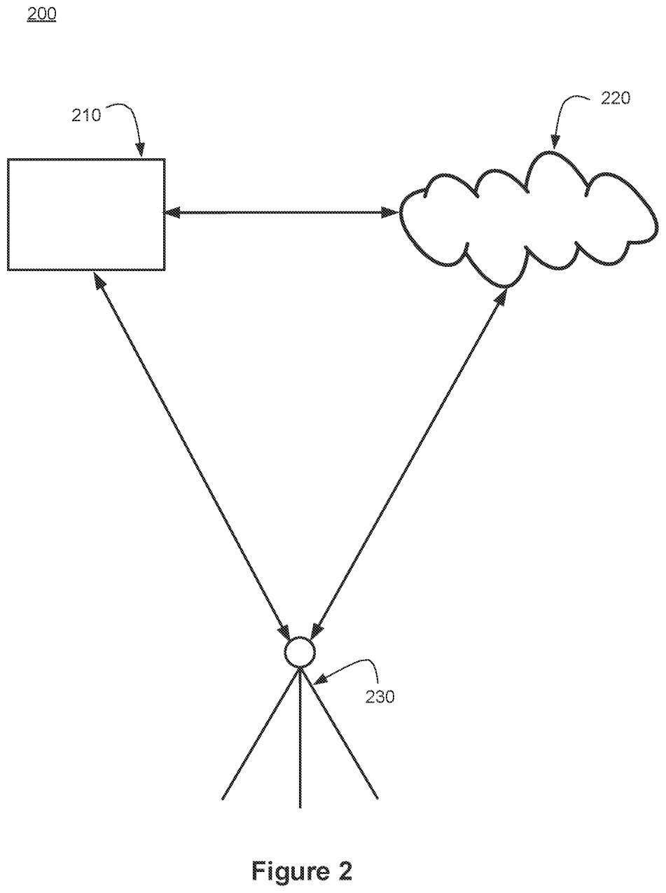

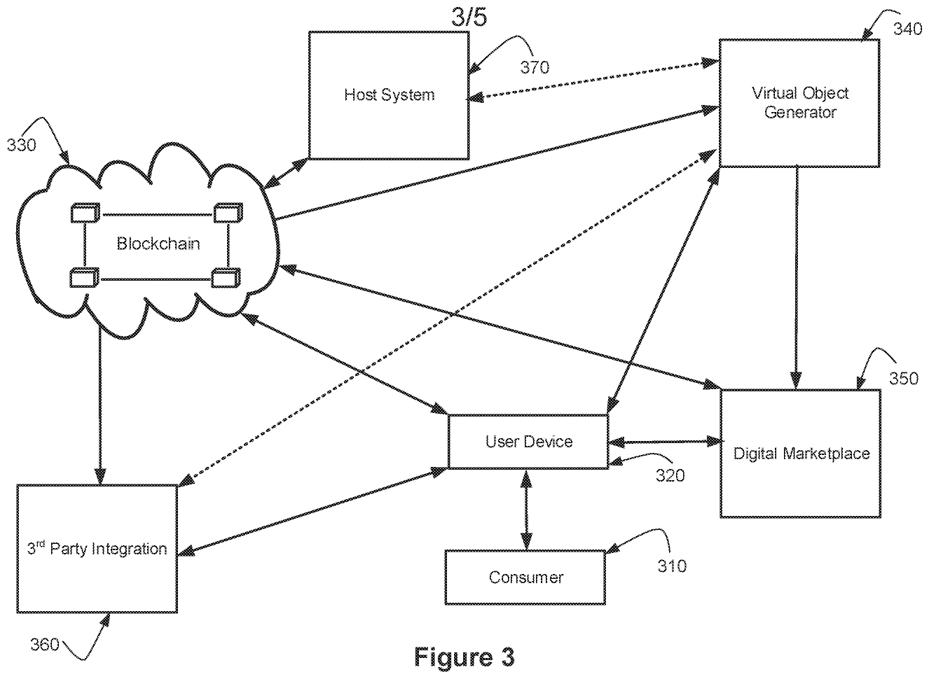

FIG. 2 illustrates an exemplary decentralized computing system, designated generally as 200. This figure includes attendant blockchain control logic for mining and exchanging blockchain-based and enabled digital real estate. Consumer 310 (of FIG. 3) communicatively couples to a remote host system 210 and/or a cloud computing system 220 via a wireless communications network 230. While illustrating a single consumer 310 communicating over the decentralized computing system 200 with a single host system 210 and a single cloud computing system 220, it is envisioned that any number of users may communicate with any number of remote computing nodes that are suitably equipped for wirelessly exchanging information and data. Wireless data exchanges between the user 310 and remote computing nodes on the decentralized computing system 200 may be conducted directly, as a non-limiting example, through direct communications, which can be accomplished using one or more blockchain-based transactions, between the host system 210 and cloud computing system 220 and a user device 320 (of FIG. 3). A non-limiting example of user device 320 could be the consumer 310's smartphone, smartwatch, or other suitable personal computing device. Communication can also be indirect, and by, as a non-limiting example, with all communications between the user 310 and other computing nodes being routed through the host system 210. Selected components of the decentralized computing system 200 are shown and will be described in detail herein. Nevertheless, the systems and devices discussed herein can include numerous additional and alternative features, and other available hardware and well-known peripheral components. As a non-limiting example, these components can be used for carrying out the various methods and functions disclosed herein. While the described system relies on a blockchain-based ledger and process for recording ownership of the digital asset, it should be understood that the present technology may operate on a public chain or a private chain, which can use one or more blockchain-based transactions, and may utilize one or more forms of cryptography, encoding, proof of work challenges, or other concepts and technologies involved in available blockchain-based standards or suitable alternative immutable databases and/or ledgers.

Host system 210 may be implemented as a high-speed server computing device of a mainframe computer capable of handling bulk data processing, resource planning, and transaction processing. For instance, host system 210 may operate as middleware in a client-server interface for conducting any necessary data exchanges and communications with one or more third party servers to complete a particular transaction. The cloud computing system 220, on the other hand, may operate as middleware for IoT (Internet of Things), WoT (Web of Things), and/or M2M (machine-to-machine) services that connects an assortment of heterogeneous electronic devices with a service-oriented architecture (SOA) via a data network. As a non-limiting example, cloud computing system 220 may be implemented as a middleware node to provide different functions for dynamically onboarding heterogeneous devices, multiplexing data from each of these devices, and routing the data through reconfigurable processing logic for processing and transmission to one or more destination applications. Network 230 may be any available type of network, including a combination of public distributed computing networks (the Internet) and secured private networks (local area network, wide area network, virtual private network). It may also include wireless and wireline transmission systems (satellite, cellular network, terrestrial network, and the like). Most if not all data transaction functions carried out by consumer 310 may be conducted, as a non-limiting example, over a wireless network such as a wireless local area network (WLAN) or cellular data network.

As a decentralized blockchain-based platform, computing system 200 can operate as an open, yet encrypted peer-to-peer network in which asset transaction records—known as blocks—can be linked via one or more cryptographic functions in a distributed, immutable ledger of interconnected blocks as a blockchain-based system. Each block in the chain can include one of more digital real estate transactions, that can be implemented using one or more blockchain-based transactions, accompanied by corroboration information that can represent validity for each transaction as assessed by peer-validation devices.

Encrypted, decentralized computing architectures can allow for identity verification and authentication for transacted assets while preventing duplication of cryptography protected digital real estate registered to the blockchain-based platform. Decentralized asset management may work by encrypting a proprietary asset field, breaking the encrypted code into tiny nonsense shards, and sending these shards to numerous different computing nodes on the blockchain-based decentralized computing network. A validated consumer can be provided with a private key that can indicate where in the network the asset can be located and how to reassemble or decrypt the file. For use as a distributed ledger, an individual blockchain-based system can typically be managed by a host administrator and distributed to multiple peers collectively adhering to a protocol for inter-node communication and block validation.

A person skilled in the art will appreciate that the disclosed system and techniques provide many advantageous technical effects that can include construction and storage of a digital asset blockchain-based system representing user-to-user transactions of digital real estate associated with real world real estate. Construction and storage of a digital asset blockchain-based system can enable networked computing devices to generate, validate and transact digital asset data, thereby improving the performance of the individual computing devices quickly and efficiently. A decentralized network of interconnected computing nodes may function as a supercomputer that has access to many parallel processors, coordinating that assignment and reassembly of various chunks of computation. In so doing, the network is more computationally efficient, rapid, and inexpensive than a centralized computing system or a single processing farm. In the same vein, decentralized storage can provide each individual computing node with tremendous storage capacity that can be limited only by the number of peer devices and their cumulative available memory space.

FIG. 3 provides a non-limiting example of the functional structure of a decentralized computing system 200, such as shown in FIG. 2. As generally illustrated, a consumer 310 may operatively interface with a user device 320 that may include one or more smart phones, tablet computers, smart watches, laptop computers, desktop computers, a standalone video game console and the like. The user device 320 can be operatively configured to communicate with one of more and an immutable public database (blockchain-based service/network 330), a virtual object generator 340, an online digital marketplace 350, and/or a third party integration service 360.

The blockchain-based system 330 can include at least one NFT registered thereon that can include information representative of the digital real estate. The consumer 310, via the user device 320, may be in possession of, or may be lined with a locker/wallet that can include a private cryptographic key that can permit the user device 320 to read the encrypted data associated with the token. This key may further enable the consumer 310 to freely transfer ownership of the token.

The digital marketplace 350 may represent a plurality of virtual objects in such a manner that permits the organized trade or sale/purchase of digital real estate between parties. Upon the closing of a sale, the digital marketplace 350 may use one or more blockchain-based transactions to update the blockchain-based system 330 with the new ownership information and facilitate the transfer of new or existing keys to the new owner. In some embodiments, the marketplace 350 may further enable various social engagement functions, such as voting or commenting on the represented virtual objects. Likewise, in some instances the marketplace 350 may be configured to assess and score the desirability of a particular virtual object based on the sum total of the digital real estate's expressed traits. Such a desirability score may then enable the marketplace (and/or consumers who participate within the marketplace) to better assess the value of the digital real estate.

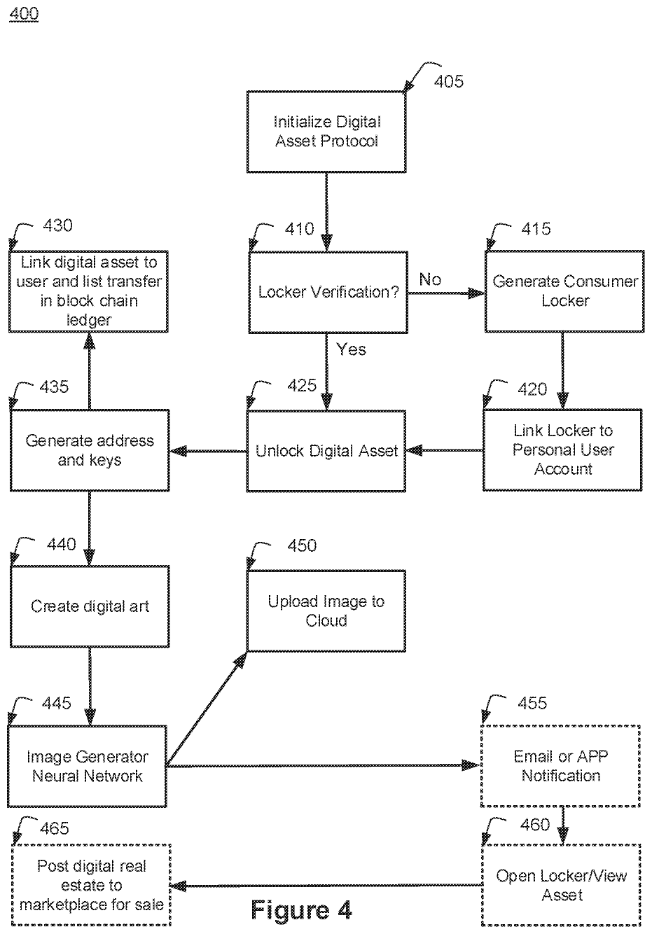

Some or all of the operations illustrated by FIG. 4 and described in further detail below may be representative of an algorithm that can correspond to processor-executable instructions that may be stored, as a non-limiting example, in main or auxiliary or remote memory, and executed, by a resident or remote controller, central processing unit (CPU), control logic circuit, or other module or device or network of devices to perform any or all of the above or below described functions that can be associated with the disclosed concepts. It should be recognized that the order of execution of the illustrated operation blocks may be changed, additional blocks may be added, and some of the blocks described may be modified, combined or eliminated.

Method 400 begins at terminal block 405 with processor executable instructions for a programmable controller or control module or similarly suitable processor to call up an initialization procedure for a protocol to generate digital real estate and an associated encrypted token key (not shown). This routine may be called-up and executed in real-time, continuously, systematically, sporadically, and/or at regular intervals. As a representative implementation of the methodology set forth in FIG. 4, the initialization procedure at block 405 may automatically commence each time new digital real estate is added to the digital platform using one or more blockchain-based transactions. Alternatively, the initialization procedure may be manually activated by an employee at a real estate office.

A consumer may utilize a portable electronic user device 320, such as smartphone or smartwatch, to launch a dedicated mobile software application (APP) or a web based applet that can collaborate with a server class (backend or middleware) computer that can include remote host system 210 to communicate with the various peer devices on decentralized computing system 200. During a communication session with the host system 210, the consumer 310 may purchase digital real estate using a corresponding feature provisioned by the APP. The consumer 310 can use one or more blockchain-based transactions to enter personal information and a method of payment to complete the transaction. Upon completion of a validated payment, the host system 210 can receive a transaction confirmation to indicate a validated transfer of the digital real estate to the consumer has been completed. This confirmation can be provided by an online store transaction module or an approved third-party electronic payment system.

Method 400 continues to decision block 410 to determine if the consumer 310 has procured a cryptocurrency wallet or other similarly suitable digital blockchain-based locker that is operable. As a non-limiting example, this checks the upload and maintaining of a location and retrieval of information for digital real estate that can be encrypted and stored in a decentralized manner. One or more blockchain-based transactions can be used to cause a cryptocurrency wallet to store public and private key pairs. A person skilled in the art will understand that this wallet does not store the cryptocurrency itself. The cryptocurrency is decentrally stored and maintained in a publicly available blockchain-based ledger. With stored keys, the owner may use one or more blockchain-based transactions to digitally sign a transaction and write it to the blockchain-based ledger. A platform dictated smart contract associated with the locker may facilitate transfer of stored assets and create a verifiable audit trail for same. If the consumer 310 has not already acquired a digital blockchain-based locker, the method 400 can continue to predefine process block 415 to set up a blockchain-based locker. By way of a non-limiting example, consumer 310 may be prompted to visit or may be automatically routed to any one of an assortment of publicly available websites that can offer a hardware wallet for cold storage of cryptocurrency and digital assets. This can include an ERC20-compatible Ethereum wallet provided by MyEtherWallet.

Once the system uses one or more blockchain-based transactions to confirm that the consumer 310 has a suitable digital blockchain-based locker, method 400 may automatically link, or prompt consumer 310 to link the digital blockchain-based locker to a personal user account as portrayed by process block 420 of FIG. 4. This may require the remote host system 210 to use one or more blockchain-based transactions to retrieve a unique owner ID code associated with the purchasing party from an encrypted relational database that can be provisioned through cloud computing system 220. At this time, a unique physical digital real estate ID code associated with the purchased digital real estate may be linked to the consumer's personal account.

Upon determining that consumer 310 has acquired a digital blockchain-based locker, or after linking the consumer's blockchain-based locker to their personal user account, the method 400 can continue to input/output block 425 to issue one or more blockchain-based transactions to enable or “unlock” cryptographic digital real estate associated with the real estate transacted at process block 405.

After receiving confirmation that cryptographic digital real estate has been authorized at input/output block 425, the method 400 can use one or more blockchain-based transactions to generate cryptographic digital real estate for the transacted real estate. This may comprise generating a unique, encrypted asset code with an address, a token, and a public and private key pair as denoted by process block 435.

Host system 210 may transmit the token, with the public key and the owner ID to a distributed blockchain-based ledger to record and peer-validate transfer of the cryptographic digital real estate to the consumer 310 on a transaction block. The method 400 can continue to process block 430 to link the cryptographic digital real estate with the unique owner ID code. This control logic may comprise one or more blockchain-based transactions that provide executable instructions for assigning the encrypted asset code to the consumer 310 and storing the public and private keys in the consumer's digital blockchain-based locker.

With continuing reference to FIG. 4 the method 400 can proceed to process block 440 to use one or more blockchain-based transactions to produce the virtual representation or “digital art” of the cryptographic digital real estate which can include a computer generated avatar of the real estate. It is also envisioned that one or more attributes of the virtual representation of the cryptographic digital real estate may be created, in whole or in part, via consumer 310. A machine learning function may be executed at predefined process block 445 in order to generate image features through a neural network. Upon completion of generating the digital art, the image may be uploaded to cloud computing system 220 at block 450. In addition, optional process block 455 may issue a digital notification, such as an email or push notification, to the consumer's smartphone, smartwatch, or other personal computing device with all related information for accessing and transferring the cryptographic digital real estate. The remote host system 210 may operate as a web server hosting a web-based graphical user interface (GUI) that can be operable to translate the data stored in the encrypted keys into a visual image that can be displayed to the consumer 310 at optional process block 460. Digital asset manipulation and use via one or more blockchain-based transactions may also be effectuated through the consumer's digital blockchain-based locker. This may comprise posting the cryptographic digital real estate to an online marketplace for sale 465.

Prospective and current owners of cryptographic digital real estate may use one or more blockchain-based transactions to buy and sell digital assets through one or more blockchain-based ledgers operating on the decentralized computing system 200. By way of a non-limiting example, a user may use one or more blockchain-based transactions to buy a new digital real estate from a verified vendor who may provide authenticated provenance records for the digital real estate.

A consumer may wish to lease, license or assign their digital real estate to any of one of more prospective consumers. In a non-limiting example, a seller can use one or more blockchain-based transactions to sell and a buyer can use one or more blockchain-based transactions to agree to purchase digital real estate for an agreed upon sum. The seller may initiate the sale process using one or more blockchain-based transactions to mark specific digital real estate in an APP as “for sale” using a corresponding soft-key “sale” button. The buyer may then use one or more blockchain-based transactions to transmit the requisite funds to the APP. The seller can then be prompted to agree to the terms of sale and finalize the transaction using one or more blockchain-based transactions. The digital real estate can then be transferred from the seller's address to the buyer's address using one or more blockchain-based transactions.

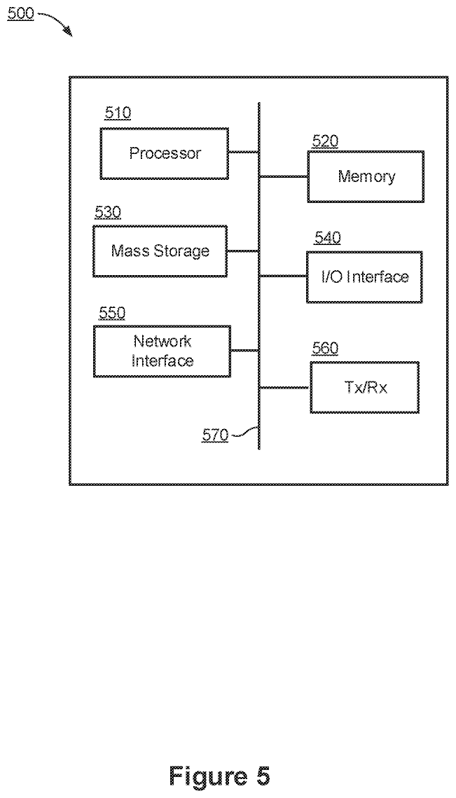

FIG. 5 is a schematic diagram of an electronic device 500 that may act as a controller or interface for embodiments of the present disclosure as described herein. For example, network infrastructure devices, end-user computers, smartphones, physical machines or servers, or other computing devices can be configured as the user device. It is also noted that controllers directing operations of embodiments of the present disclosure may be microcontrollers or microprocessors which execute program instructions stored in-memory, or other digital or analog circuitry, or a combination thereof.

As shown, the device includes a processor 510, such as a Central Processing Unit (CPU) or specialized processors such as a Graphics Processing Unit (GPU) or other such processor unit, memory 520, non-transitory mass storage 530, I/O interface 540, network interface 550, and a transceiver 560, all of which are communicatively coupled via bi-directional bus 570. According to certain embodiments, any or all of the depicted elements may be utilized, or only a subset of the elements may be used. Further, the device 500 may contain multiple instances of certain elements, such as multiple processors, memories, or transceivers. Also, elements of the hardware device may be directly coupled to other elements without the bi-directional bus.

The memory 520 may include any type of non-transitory memory such as static random-access memory (SRAM), dynamic random access memory (DRAM), synchronous DRAM (SDRAM), read-only memory (ROM), any combination of such, or the like. The mass storage element 530 may include any type of non-transitory storage device, such as a solid-state drive, hard disk drive, a magnetic disk drive, an optical disk drive, USB drive, or any computer program product configured to store data and machine executable program code. According to certain embodiments, the memory 520 or mass storage 530 may have recorded thereon statements and instructions executable by the processor 510 for performing any of the aforementioned method steps described above.

It will be appreciated that, although specific embodiments of the technology have been described herein for purposes of illustration, various modifications may be made without departing from the scope of the technology. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, server, PDA, or the like and pursuant to one or more, or a part of one or more, program elements, modules or objects generated from any programming language, such as C++, Java, or the like. In addition, each step, or a file or object or the like implementing each said step, may be executed by special purpose hardware or a circuit module designed for that purpose.

Although the present disclosure has been described with reference to specific features and embodiments thereof, it is evident that various modifications and combinations can be made thereto without departing from the invention. The specification and drawings are, accordingly, to be regarded simply as an illustration of the disclosure as defined by the appended claims, and are contemplated to cover any and all modifications, variations, combinations or equivalents that fall within the scope of the present disclosure.

We claim:

1. A method for automating generation a cryptographic digital asset compromising:
Receiving, a transaction confirmation indicative of a validated transfer of digital real estate from a first party to a second party using one or more blockchain-based transactions, the digital real estate being located within a blockchain-based digital platform and being associated with the digital assets;
determining an owner identification code associated with the second party from an encrypted relational database;
generating the cryptographic digital asset associated with the digital real estate and the cryptographic digital asset or a digital real estate ID code using one or more blockchain-based transactions wherein the cryptographic digital asset is transferable separate from the digital real estate;
linking the cryptographic digital assets with the owner identification code using one or more blockchain-based transactions;
transmitting to a distributed blockchain ledger, the digital real estate ID code and the owner identification code to record a transfer of the cryptographic digital asset to the second party on a transaction block using one or more blockchain-based transactions;
receiving a digital transfer proposal with a request to transfer the cryptographic digital asset to a third party using one or more blockchain-based transactions;
determining a new owner ID code associated with the third party;
linking the cryptographic digital asset with the new owner ID code using one or more blockchain-based transactions; and
transmitting the unique digital real estate ID code and the new owner ID code to the distributed blockchain ledger for recordation on a new transaction block using one or more blockchain-based transactions.

2. A method for automating generation a cryptographic digital asset compromising:
receiving a transaction confirmation indicative of a validated transfer of digital real estate from a first party to a second party using one or more blockchain-based transactions, the digital real estate being located within a blockchain-based digital platform and being associated with the digital assets;
determining an owner identification code associated with the second party from an encrypted relational database using one or more blockchain-based transactions;
generating the cryptographic digital asset associated with the digital real estate and a digital real estate ID code using one or more blockchain-based transactions;
linking the cryptographic digital assets with the owner identification code;
transmitting to a distributed blockchain-based ledger, the digital real estate ID code and the owner identification code to record a transfer of the cryptographic digital asset to the second party on a transaction block using one or more blockchain-based transactions;
receiving a digital transfer proposal with a request to transfer the cryptographic digital asset to a third party using one or more blockchain-based transactions;
determining a new owner ID code associated with the third party;
linking the cryptographic digital asset with the new owner ID code; and
transmitting the unique digital real estate ID code and the new owner ID code to the distributed blockchain-based ledger for recordation on a new transaction block using one or more blockchain-based transactions.

3. A method for automating generation a cryptographic digital asset compromising:
receiving a transaction confirmation indicative of a validated transfer of digital real estate from a first party to a second party using one or more blockchain-based transactions, the digital real estate being located within a blockchain-based digital platform and being associated with the digital assets;
determining an owner identification code associated with the second party from an encrypted relational database using one or more blockchain-based transactions;
generating the cryptographic digital asset associated with the digital real estate and the cryptographic digital asset wherein the cryptographic digital asset is transferable separate from the digital real estate using one or more blockchain-based transactions;
linking the cryptographic digital assets with the owner identification code;
transmitting to a distributed blockchain-based ledger, the digital real estate ID code and the owner identification code to record a transfer of the cryptographic digital asset to the second party on a transaction block using one or more blockchain-based transactions;
receiving a digital transfer proposal with a request to transfer the cryptographic digital asset to a third party using one or more blockchain-based transactions;
determining a new owner ID code associated with the third party;
linking the cryptographic digital asset with the new owner ID code; and
transmitting the unique digital real estate ID code and the new owner ID code to the distributed blockchain-based ledger for recordation on a new transaction block using one or more blockchain-based transactions.
